(19) United States
(12) Patent Application Publication
(10) Pub. No.: US 2011/0161370 A1
(43) Pub. Date: Jun. 30, 2011

(54) APPARATUS, PROGRAM, AND METHOD FOR FILE MANAGEMENT

(75) Inventors: Takeshi Miyamae, Kawasaki (JP); Yoshitake Shinkai, Kawasaki (JP)

(73) Assignee: FUJITSU LIMITED, Kawasaki-shi (JP)

(21) Appl. No.: 12/975,430

(22) Filed: Dec. 22, 2010

(30) Foreign Application Priority Data
Dec. 24, 2009 (JP) 2009-291829

(51) Int. Cl. G06F 17/30

(52) U.S. Cl. 707/783; 707/E17.143

(57) ABSTRACT

In a file management apparatus, upon receipt of an access request from a file access device, a device access rights determination unit determines whether to grant the file access device access to a file. In addition, a user access rights determination unit determines whether to grant the user who made the access request through the file access device, the access to the file. Then, when the device access rights determination unit and the user access rights determination unit both grant the access, a file access unit accesses the file stored in the storage device according to the access request.

### CROSS-REFERENCE TO RELATED APPLICATION

This application is based upon and claims the benefit of priority of the prior Japanese Patent Application No. 2009-291829, filed on Dec. 24, 2009, the entire contents of which are incorporated herein by reference.

### FIELD

This invention is related to an apparatus, program, and method for file management.

### BACKGROUND

A UID/GID scheme is prevalent as a scheme of user authentication for a file system. This UID/GID scheme is designed to manage access privileges on each file in association with the user IDs of users or the group IDs (GID) of groups to which the users belong. The access privileges include read permission/prohibition, write permission/prohibition, and execute permission/prohibition.

Recently, Kerberos which uses private key encryption has been developed for high-security user authentication. Kerberos uses a Kerberos server to perform user authentication and issue tickets to users for using services. A user uses a terminal device to acquire a ticket from the Kerberos server. Then, the user sends a service request including the acquired ticket to a server which provides a desired service, to thereby receive the service from the server. The services of the server include a file management service through a file server.

For example, there is an access control method that uses Kerberos to control access to objects without local user accounts.

By the way, there is a company that offers a file storage service as part of their services. As this service continues, an amount of stored data increases. Then, they may suffer from a shortage of system resources. If this happens, they expand the system. However, it is a burden on the company to appropriately determine the necessity of the system expansion and actually expand the system. Therefore, they may commission another organization to perform the file management.

A file management service provider company which has been commissioned to manage files builds a file server for each client company, for example. Then the file management service provider company expands the file server for each client company according to an amount of resources needed by the client company.

Please refer to Japanese Laid-open Patent Publication No. 2004-5647.

For such a file management service provider company that provides the service to a plurality of client companies, it is troublesome to build and manage file servers for the respective client companies. In addition, efficient use of resources is not achieved. To solve these problems, it may be considered to integrate the file servers for the respective client companies into one system.

However, to realize the integration of file servers which currently exist for the respective client companies, into one system, another problem arises because it is difficult to integrate management of access rights to files for the users of the client companies.

For example, in the case where each client company manages access rights for users by using the UID/GID scheme, the client companies independently set UIDs and GIDs to their users. Therefore, if the file servers for the client companies are integrated into one system, there may be overlapping UIDs and GIDs. To avoid the overlaps of UIDs and GIDs, the administrator of the file management service provider company may reset the UIDs and GIDs of all users to perform the whole user management for the client companies. However, the change of user UIDs/GIDs used in the existing systems involve change of the information of access rights to all files to be managed. As a result, a significant amount of information needs to be revised. Therefore, it is daunting to change the UIDs/GIDs of all users.

By applying Kerberos to the access environment of every user terminal device, it becomes possible to manage the access rights to files for the users of a plurality of client companies by using Kerberos after the systems are integrated. However, as compared with the UID/GID scheme, Kerberos uses keys, needs to manage the keys, and needs to set access rights in a different manner.

Therefore, to change the user authentication method in the file system from the UID/GID scheme to Kerberos, users need to undo the whole process such as regeneration of keys and resetting of access rights, which imposes excess loads on the users. If there are thousands of registered users, it is hard to change the management mode from the UID/GID scheme to Kerberos.

### SUMMARY

According to an aspect of the invention, a file management apparatus for managing files stored in a storage device includes: a communication interface that receives from a file access device an access request for accessing a file, the access request including device identification information of the file access device and user identification information of a user; and a control device that performs first determination on whether the file access device has access rights to the file, based on the received device identification information, performs second determination on whether the user has access rights to the file, based on the received user identification information, and when the first determination and second determination both determine that the access rights are confirmed, grants the access request for accessing the file.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of a first embodiment;

FIG. 2 illustrates an example system configuration according to a second embodiment;

FIG. 3 illustrates an example hardware configuration of a file management apparatus;

FIG. 4 is a functional block diagram of each server;

FIG. 5 illustrates a directory structure of a local file system;

FIG. 6 illustrates example modes stored in an mode memory unit;

FIG. 7 is a sequence diagram of a file access process;

FIG. 8 illustrates an example data structure of an NFS request to be output from an NFS client unit;

FIG. 9 illustrates an example data structure of a service ticket memory unit;

FIG. 10 illustrates an NFS request having a nickname added thereto; and

FIG. 11 is a flowchart of a file access process to be executed by an NFS server unit.

### DESCRIPTION OF EMBODIMENTS

Hereinafter, preferred embodiments will be described with reference to the accompanying drawings, wherein like reference numerals refer to like elements throughout.

### First Embodiment

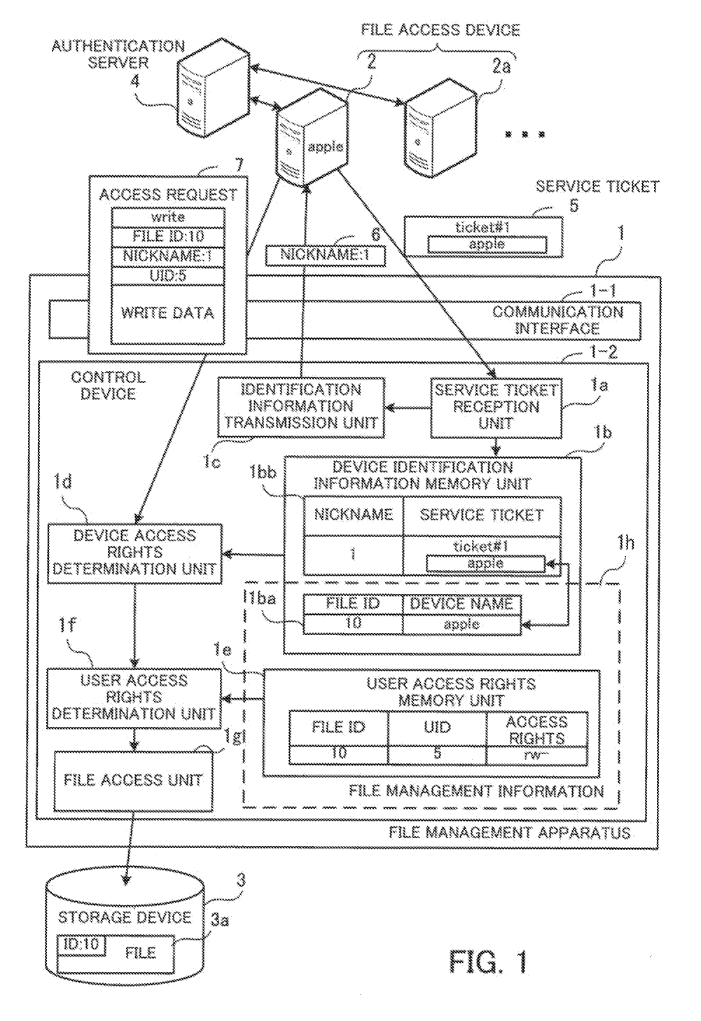

FIG. 1 is a functional block diagram of a first embodiment. A system according to this first embodiment includes a file management apparatus 1, a plurality of file access devices 2, 2a, . . . , and an authentication server 4. The file management apparatus 1 is locally connected to a storage device 3.

The file management apparatus 1 includes a communication interface 1-1 and a control device 1-2. The communication interface 1-1 receives from the file access device 2 an access request 7 for accessing a file, which includes the identification information of the file access device 2 and the identification information of a user. The communication interface 1-1 also receives a service ticket from the file access device 2. This service ticket 5 includes the name (device name) of the file access device 2, for example. The communication interface 1-1 also sends a nickname 6 which is uniquely associated with the service ticket 5, to the file access device 2 which has sent the service ticket 5.

The control device 1-2 is designed to manage files stored in the locally connected storage device 3. To this end, the control device 1-2 includes a service ticket reception unit 1a, a device identification information memory unit 1b, an identification information transmission unit 1c, a device access rights determination unit 1d, a user access rights memory unit 1e, a user access rights determination unit 1f, and a file access unit 1g, as illustrated in FIG. 1.

The service ticket reception unit 1a receives, via the communication interface 1-1, the service ticket 5 which was issued by the authentication server 4 to the file access device 2 having access rights to the storage device 3. Then, the service ticket reception unit 1a stores the received service ticket 5 in association with the nickname 6 of the file access device 2 in the device identification information memory unit 1b.

The device identification information memory unit 1b stores the nickname 6 as the identification information of the file access device 2 which is permitted to access files stored in the storage device 3. This nickname 6 is stored in association with the service ticket 5 received by the service ticket reception unit 1a. The device name of the file access device 2 included in the service ticket 5 associates the file access device 2 with the nickname 6.

As illustrated in FIG. 1, the device identification information memory unit 1b is divided into an authorized device name memory area 1ba and a service ticket memory area 1bb. The authorized device name memory area 1ba is a memory area for storing the device name of the file access device 2 which is permitted to access a file stored in the storage device 3, in association with the file. The service ticket memory area 1bb is a memory area for storing the nickname 6 and the service ticket 5 in association with each other. The authorized device name memory area 1ba and the service ticket memory area 1bb have records linked to each other via device name. This record link via device name provides association between the file ID of a record in the authorized device name memory area 1ba and the nickname 6 of a record in the service ticket memory area 1bb.

The identification information transmission unit 1c sends the nickname 6 which has been stored in the device identification information memory unit 1b in association with the service ticket 5, via the communication interface 1-1 to the file access device 2 which has sent the service ticket 5.

The device access rights determination unit 1d receives an access request 7 for accessing a target file 3a, from the file access device 2 via the communication interface 1-1. Upon receipt of the access request 7, the device access rights determination unit 1d searches the device identification information memory unit 1b to determine whether the file access device which has sent the access request has access rights. For example, the device access rights determination unit 1d searches the authorized device name memory area 1ba to retrieve a device name corresponding to the file identifier (ID) of the target file 3a specified by the access request 7. The device access rights determination unit 1d then searches the service ticket memory area 1bb to retrieve a nickname corresponding to a service ticket 5 including the retrieved device name. If the nickname 6 retrieved from the device identification information memory unit 1b matches the nickname included in the access request 7, the device access rights determination unit 1d determines that the access rights are confirmed.

The user access rights memory unit 1e stores access rights to the file 3a stored in the storage device 3 with respect to at least user ID (UID). The access rights are information on whether to permit writing into the file 3a, whether to permit reading from the file 3a, and whether to permit execution of a program in the file 3a. These access rights are set in association with a combination of file ID and UID.

By the way, the data items stored in the user access rights memory unit 1e and those in the authorized device name memory area 1ba of the device identification information memory unit 1b are associated with the file 3a through file ID. Therefore, these data items may be collectively stored as file management information 1h such as an mode for UNIX (registered trademark), for a local file system of the file management apparatus 1 to use in order to manage the file 3a.

Upon receipt of the access request 7, the user access rights determination unit 1f searches the user access rights memory unit 1e to determine whether the user has access rights to the target file 3a. For example, the user access rights determination unit 1f compares UIDs registered in association with the file ID of the target file 3a with the UID included in the access request 7. If there is a record with a matching UID, the user access rights determination unit 1f checks the access rights in the record. Then, the user access rights determination unit 1f grants the access if the access rights allow an access type included in the access request 7.

The file access unit 1g accesses the target file 3a according to the access request 7 when the file access device 2 is granted the access and the user is confirmed to have the access rights.

The file access devices 2, 2a, independently administrate users. That is to say, the file access devices 2, 2a, independently produce a user account with a unique UID to be used only on the own file access devices 2, 2a, . . . . The file access device 2, 2a, . . . accesses the file 3a of the storage device 3 via the file management apparatus 1 according to user operation. For example, the file access device 2 transmits an access request 7 to the file management apparatus 1 when accessing the file 3a. The access request 7 includes the nickname 6 of the requesting file access device 2 and the UID of the user who will use the file to be accessed. The UID is used only on the file access device 2. For example, the nickname 6 is information that indicates that the authentication server 4 has authenticated the file access device 2 has proper rights to access the storage device 3. The access request 7 further includes an identifier (file ID) of the target file to be accessed, an access type (Read, Write, Execute, . . . ), and write data to be written if this request is a write access request.

The authentication server 4 authenticates that the file access device 2, 2a, . . . has at least proper access rights to the storage device 3. When the files of the storage device 3 need to be protected, the file access device 2, 2a, . . . need to have access rights to the storage device 3. File management services provided by the file system server 1 include file encryption/decryption service besides simple file access service. Having at least access rights to the storage device 3, the file access devices 2, 2a, are granted access to the storage device 3. In this embodiment, file access devices which are granted access are limited for each file stored in the storage device 3.

Such a system works as follows, for example.

The file access device 2 requests the authentication server 4 to authenticate that the file access device 2 has rights to use file management service provided by the file management apparatus 1. If the file access device 2 has proper rights to use the service, the authentication server 4 issues a service ticket 5 including the device name to the file access device 2.

Upon receipt of the service ticket 5, the file access device 2 sends the service ticket 5 to the file management apparatus 1. Then, the service ticket reception unit 1a of the file management apparatus 1 generates a nickname 6 uniquely identifying the file access device 2, and then stores the service ticket 5 in association with the nickname 6 in the device identification information memory unit 1b. The generated nickname 6 is also sent to the file access device 2 through the identification information transmission unit 1c.

It is now assumed that a user operates the file access device 2 to access the file 3a. In this case, the file access device 2 sends an access request 7 to the file management apparatus 1.

Upon receipt of the access request 7, the device access rights determination unit 1d of the file management apparatus 1 determines whether to grant the file access device 2 the access to the target file 3a. For example, the access is granted if the device name included in the service ticket corresponding to the nickname included in the access request 7 has been registered in the authorized device name memory area 1ba in association with the file ID of the target file 3a.

In addition, upon receipt of the access request 7, the user access rights determination unit if of the file management apparatus 1 determines whether to grant the user of the requesting file access device 2 the access to the target file 3a. For example, the access is granted if there is a record that stores the UID included in the access request 7 in association with the file ID of the target file 3a and the access rights set in the record allow the access type included in the access request 7.

When the device access rights determination unit 1d and the user access rights determination unit if both grant the access, the file access unit 1g accesses the target file 3a of the storage device 3 according to the access request 7. If the access request 7 is a write access request, then the write data included in the access request 7 is written in the target file 3a.

As described above, in addition to the access rights management using UIDs, the access rights management using nicknames which are identification information of the file access devices 2, 2a, is performed. This enables a single file management apparatus 1 to provide a file management service to a plurality of file access devices 2, 2a, . . . which independently set UIDs. Even if different users have the same UID on different file access devices, their access rights are judged through the device access rights determination. This makes it easy for the file management apparatus 1 to collectively provide the file management service to existing file access devices 2, 2a, . . . .

In addition, the user access rights determination use UIDs. Therefore, even under a system environment where different file management apparatuses provide their file management services to file access devices 2, 2a, . . . , their file management service functions are integrated on a single file management apparatus. That is, even when the file management apparatuses are integrated, the UIDs assigned to users independently by the file access devices 2, 2a, . . . do not need to be changed.

Further, what are authenticated by the authentication server 4 are not individual users but the file access devices 2, 2a, . . . . Therefore, users do not need to request the authentication server 4 to perform authentication, which alleviates a burden on the users.

Referring to FIG. 1, the authentication server 4 authenticates that the file access device 2, 2a, . . . has proper access rights to the storage device 3. This mechanism is derived from the condition that a high security level is requested for the file management apparatus 1. On the other hand, another mechanism than the authentication server 4 may exist to maintain the security for access from the file access devices 2, 2a, . . . to the file management apparatus 1. For example, such a case is considered that the file access devices 2, 2a, . . . and the file management apparatus 1 are provided on a corporate intranet and are managed by the same administrator. If such a mechanism is present for maintaining the security or if a high security level is not demanded, the authentication by the authentication server 4 may not be performed. In this case, the device names of the file access devices 2 2a, . . . may be used as the identification information of the file access devices 2, 2a, . . . . If the device name is included as identification information in the access request 7, instead of the nickname 6, it is possible for the device access rights determination unit 1d to search only the authorized device name memory area 1ba in order to determine whether to grant the access. That is to say, if the device name memory area 1ba stores the device name included in the access request 7 in association with the file ID of a target file, the device access rights determination unit 1d grants the access.

In addition, referring to FIG. 1, the nickname issued by the file management apparatus 1 is used as information indicating that the authentication server 4 has authenticated the file access device 2 has proper access rights to the storage device 3. This nickname 6 has a data size that is capable of representing only as many numerical numbers as there are the file access devices. Therefore, as compared with the service ticket 5, the nickname 6 has a smaller data size. This suppresses an increase in the data size of the access request 7 as minimum as possible, and also allows the access request 7 to include information indicating that the file access device 2 has been authenticated to have proper access rights to the storage device 3.

On the other hand, the service ticket 5 may be included in the access request 7 as long as an increase in the data size is acceptable. This makes it possible to eliminate the process of the file access device 2, which sends the service ticket 5 to the file management apparatus 1 and receives the nickname 6. In addition, the service ticket reception unit 1a and the identification information transmission unit 1c are no more needed in the file management apparatus 1. By including the service ticket 5 in the access request 7, instead of the nickname 6, the service ticket 5 may be treated as the identification information of the file access device 2 sending the access request 7 because the service ticket 5 includes the device name.

Further, by including the service ticket 5 in the access request 7, instead of the nickname 6, it becomes possible for the device access rights determination unit 1d to search only the authorized device name memory area 1ba in order to determine whether to grant the access. That is, if the authorized device name memory area 1ba stores the device name included in the service ticket 5 in association with the file ID of a target file, the device access rights determination unit 1d grants the access.

### Second Embodiment

This section describes the second embodiment. This embodiment uses a Kerberos server as an authentication server that issues an access ticket.

In general, Kerberos authentication is performed for authenticating users. Instead, this embodiment causes a Kerberos server to authenticate file access devices.

Client companies which use services of a file management apparatus are called “tenants”. In the second embodiment, such companies are referred to as “clients”, a file access device is provided in each client, and its device name is called “client name”.

A ticket which is issued through the Kerberos authentication has a field for setting a principal name. To have the ticket include the name of the file access device, a client name is set in the principal name field.

The following describes the second embodiment in detail.

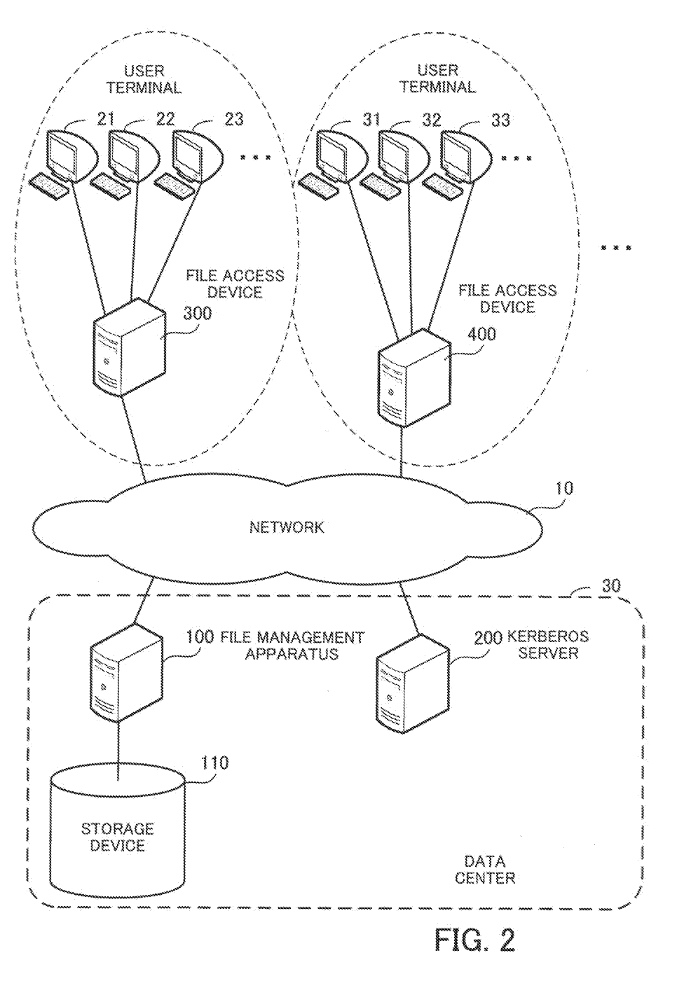

FIG. 2 illustrates an example system configuration of the second embodiment. A file management apparatus 100, a Kerberos server 200, and a plurality of file access devices 300, 400, are connected to a network 10. Referring to FIG. 2, the file management apparatus 100 and the Kerberos server 200 are installed at a data center 30 of a file management service provider company.

The file management apparatus 100 has a storage device 110. The storage device 110 may be a high-speed and high-reliability device such as RAID (Redundant Arrays of Inexpensive Disks) 5. The file management apparatus 100 is a computer that inputs and outputs in/from the storage device 110 data of users who are administrated independently by the file access devices 300, 400, . . . . The file management apparatus 100 also manages access rights to each data of the storage device 110 for the users.

The Kerberos server 200 is a computer which performs Kerberos authentication. For example, the Kerberos server 200 authenticates the file access devices 300, 400, . . . , and issues tickets to the file access devices 300, 400, . . . .

A plurality of user terminals 21, 22, 23, . . . are connected to the file access device 300. The file access device 300 provides various services to users using the user terminals 21, 22, 23, . . . . The services the file access device 300 provides include making access to data managed by the file management apparatus 100. The file access device 300 receives user's authentication information from the user terminal 21, 22, 23, . . . , and performs user authentication based on the user's authentication information. The user's authentication information includes a user's UID and password.

The file access device 400 provides various services to users using the user terminals 31, 32, 33, . . . . The file access device 400 functions in the same way as the file access device 300.

The file management apparatus 100 and the file access devices 300, 400, . . . cooperate with each other to make up one large-scale file system. This file system uses the Kerberos server 200 to perform the Kerberos authentication, thereby securing security. In the file system, the files of the storage device 110 are operated in response to requests from the user terminals 21, 22, 23, . . . , 31, 32, 33, . . . . That is, users using the file access devices 300, 400, . . . share the file management function of the file management apparatus 100.

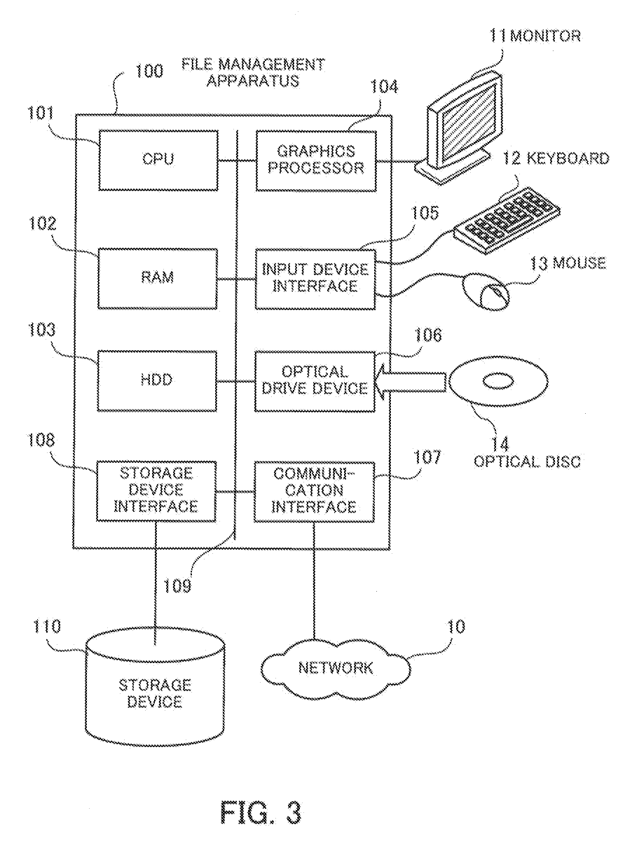

FIG. 3 illustrates an example hardware configuration of a file management apparatus. The file management apparatus 100 is entirely controlled by a CPU (Central Processing Unit) 101. Connected to the CPU 101 via a bus 109 are a RAM (Random Access Memory) 102 and a plurality of peripheral devices.

The RAM 102 serves as a main memory device of the file management apparatus 100, and temporarily stores part of an OS (Operating System) program and application programs to be executed by the CPU 101, as well as various data for CPU processing.

The peripheral devices include a hard disk drive (HDD) 103, a graphics processor 104, an input device interface 105, an optical drive device 106, a communication interface 107, and a storage device interface 108.

The HDD 103 magnetically writes and reads data on/from a local disk. The HDD 103 serves as a secondary storage device of the file management apparatus 100. The HDD 103 stores the OS and application programs, as well as various data. A semiconductor memory device such as a flash memory may be used as the secondary memory device.

The graphics processor 104 is connected to a monitor 11, and is designed to display images on the screen of the monitor 11 under the control of the CPU 101. The monitor 11 may be a display device using CRT (Cathode Ray Tube) or a crystal liquid display device.

The input device interface 105 is connected to a keyboard 12 and a mouse 13, and is designed to transfer signals from the keyboard 12 and mouse 13 to the CPU 101. The mouse 13 is an example of pointing devices, and another pointing device such as touch panel, tablet, touch pad, or trackball may be used instead.

The optical drive device 106 reads data from an optical disc 14 by using laser light. The optical disc 14 is a portable recording medium on which data is recorded so as to be read by reflected light. The optical disc 14 may be a DVD (Digital Versatile Disc), DVD-RAM, CD-ROM (Compact Disc Read Only Memory), CD-R (Recordable)/RW (ReWritable).

The communication interface 107 is connected to the network 10, and is designed to communicate data with other computers such as the file access devices 300, 400, . . . over the network 10.

The storage device interface 108 is connected to the storage device 110, and is designed to write and read data on/from the storage device 110 under the control of the CPU 101.

The CPU 101 and RAM 102 illustrated in FIG. 3 is just an example processing function and memory function that the control device 1-2 of FIG. 1 has. In addition, the communication interface 107 illustrated in FIG. 3 is an example of the communication interface 1-1 of FIG. 1.

The processing functions of this embodiment are realized with such a hardware configuration. The Kerberos server 200, file access devices 300, 400, . . . , and user terminals 21, 22, 23, . . . , 31, 32, 33, . . . may have the same hardware configuration as the file management apparatus 100 illustrated in FIG. 3, except that a function equivalent to the storage device interface 108 may not be provided in the Kerberos server 200, file access devices 300, 400, . . . , and user terminals 21, 22, 23, . . . , 31, 32, 33, . . . .

The following describes the functions of each server.

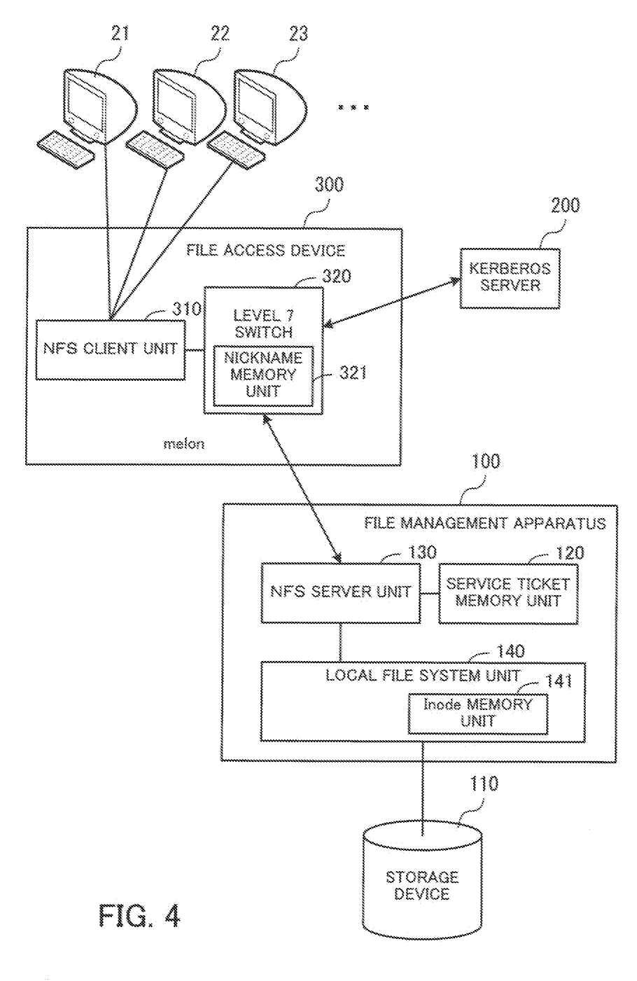

FIG. 4 is a functional block diagram of each server. FIG. 4 illustrates the functions of one file access device 300 as an example, and the other file access devices 400, . . . , may have the same functions.

The file access device 300 includes an NFS (Network File System) client unit 310 and a level 7 switch 320.

The NFS client unit 310 manages access to data managed by the file management apparatus 100. More specifically, the NFS client unit 310 receives an access request for accessing data managed by the file management apparatus 100, from a user terminal 21, 22, 23, . . . . Upon receipt of the access request, the NFS client unit 310 outputs an NFS request to the level 7 switch 320.

The NFS client unit 310 is designed to accept only access requests from user terminals used by users who have been authenticated by the file access device 300. For example, the authentication information of each user who uses the user terminals 21, 22, 23, . . . has been stored in the file access device 300. The authentication information includes the username and password associated with a UID. For example, the user uses the user terminal 21 to access the file access device 300, and enters the username and password. The entered username and password are sent from the user terminal 21 to the file access device 300. The file access device 300 authenticates the user using the user terminal 21 if it stores the authentication information that matches the combination of the received username and password. Since then, the file access device 300 discriminates requests from the user of the user terminal 21 from requests from the other users, based on the UID of the authentication information used in the authentication until the user logs out.

The UIDs of authentication information held by the file access device 300 are unique only within the file access device 300. That is to say, the same UID may be used in authentication information stored in the file access device 400.

The level 7 switch 320 performs packet routing based on information of application layer (layer 7) of OSI (Open Systems Interconnection) reference model. More specifically, when packets output from the NFS client unit 310 are an NFS request generated by the NFS client unit 310, the level 7 switch 320 transfers the packets to the file management apparatus 100.

The file access device 300 is given a client name “melon”. This client name is previously stored in a memory area of the file access device 300 such as a RAM. The level 7 switch 320 recognizes the previously stored client name of the file access device 300. The level 7 switch 320 also adds a nickname associated with a service ticket of the file access device 300, to the NFS request to be transferred to the file management apparatus 100.

More specifically, the level 7 switch 320 logs in to the Kerberos server 200 to acquire a service ticket therefrom when the file access device 300 is activated. Then, the level 7 switch 320 acquires a nickname corresponding to the service ticket from the file management apparatus 100 before transferring an NFS request to the file management apparatus 100. Then, after adding the nickname received from the NFS client unit 310 to the NFS request, the level 7 switch 320 transfers the NFS request to the file management apparatus 100.

The level 7 switch 320 includes a nickname memory unit 321 that functions to store a nickname that the level 7 switch 320 has acquired from the file management apparatus 100. For example, a partial memory area of the RAM or HDD of the file access device 300 is used as the nickname memory unit 321.

The file management apparatus 100 includes a service ticket memory unit 120, NFS server unit 130, and local file system unit 140.

The service ticket memory unit 120 functions to store service tickets for service ticket authentication received from the file access device 300. For example, a partial memory area of the RAM 102 or HDD 103 of the file management apparatus 100 is used as this service ticket memory unit 120.

The NFS server unit 130 accesses files of the storage device 110 in accordance with NFS requests from the file access device 300. More specifically, upon receipt of a service ticket from the file access device 300, the NFS server unit 130 sends a nickname corresponding to the service ticket. Then, upon receipt of an NFS request having the nickname added thereto from the file access device 300, the NFS server unit 130 determines whether to grant the access to a target file, based on the service ticket corresponding to the nickname. At this time, the NFS server unit 130 acquires the mode of the target file via the local file system unit 140. The acquired mode includes a client name as well as the access rights to the file, for each UID/GID. If the client name corresponding to the nickname matches the client name associated with the target file and the access conditions set to the target file for the UID/GID allow the access, the NFS server unit 130 grants the access. Granting the access, the NFS server unit 130 requests the local file system unit 140 to operate the target file according to the received NFS request.

The local file system unit 140 manages the directories and files of the storage device 110. More specifically, the local file system unit 140 has an mode memory unit 141. This mode memory unit 141 functions to store the modes of the directories and files of the storage device 110. For example, a partial memory area of the RAM 102 or HDD 103 is used as this mode memory unit 141. The local file system unit 140 creates and updates the modes in the mode memory unit 141, and gives an mode to the NFS server unit 130 in response to a request from the NFS server unit 130. The local file system unit 140 operates the files of the storage device 110 according to requests from the NFS server unit 130. The local file system unit 140 may be realized by modifying a Linux (registered trademark) ext3 file system.

The local file system unit 140 creates a directory for each client in the storage device 110, and stores the files of the client under this directory.

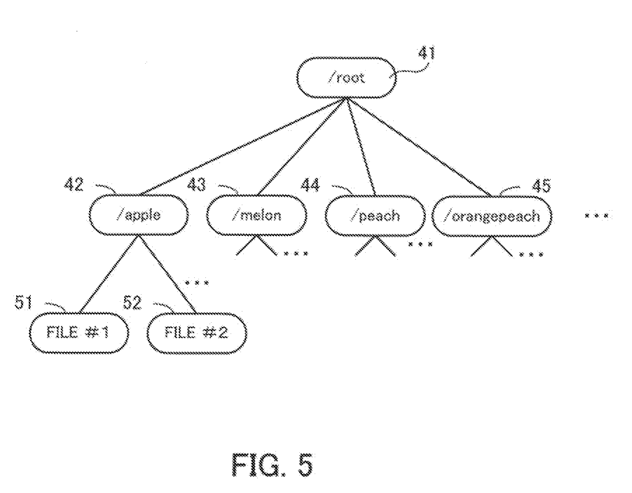

FIG. 5 illustrates a directory structure of a local file system. Directories 42, 43, 44, 45, . . . for respective clients are provided under the root directory 41. Referring to FIG. 5, each directory is given the client name of a client which uses the directory, as a directory name. For example, the directory 42 has a directory name of “apple”.

A plurality of files 51, 52, . . . are stored under the directory 42. Similarly, a plurality of files are stored under the other directories 43, 44, 45, . . . .

This directory 42 is accessible only from the file access device corresponding to the client name of “apple” identified by the directory name. In addition, the files 51 and 52 under the directory 42 are also accessible only from the file access device corresponding to the client name of “apple” identified by the directory name of the higher level directory.

Information on file access devices which are permitted to access directories and files is registered as extended attribute in the modes of the directories and files.

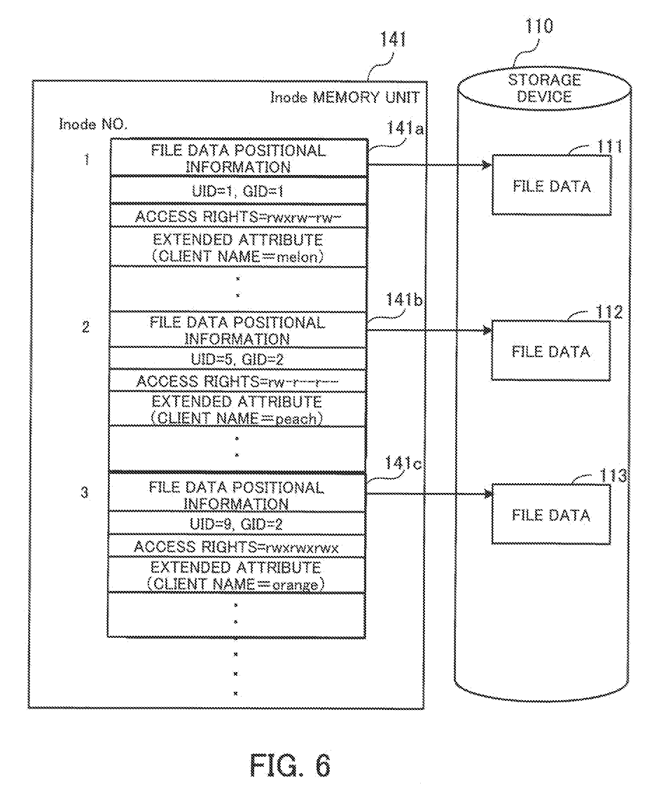

FIG. 6 illustrates example modes stored in an mode memory unit. The mode memory unit 141 stores a plurality of modes 141a, 141b, 141c, . . . .

Each mode 141a, 141b, 141c, . . . is given an mode number. Each directory and file is identified by mode number in the local file system.

Each mode 141a, 141b, 141c, . . . includes information such as file data positional information, UID/GID, access rights, and extended attribute. The file data positional information indicates where in the storage device 110 the substantial data (file data 111, 112, 113, . . . ) of the directory or file corresponding to the mode is stored. For example, this file data positional information is made up of the first block number and data size of a storage area storing the file data 111.

UID/GID are the user ID and group ID of a file owner. These UID/GID are set independently by the file access device 300 and 400. That is, the UID/GID that correspond to the authentication information used in the user authentication by the file access device 300, 400, . . . are used as the identification information of the file owner.

The access rights are information called permission. What is set is which types of file access are permitted, for an owner, users of a group in which the owner is a member, and users who do not belong to the owner's group. The access rights include read, write, and execute.

The first to third characters from the left represent the owner's privileges (Owner privileges). The fourth to sixth characters from the left represent the users' privileges (Group privileges) of users of the group in which the owner is a member. The seventh to ninth characters represent users' privileges (Other privileges) of users who do not belong to the owner's group. Privileges are expressed by three characters. The left character represents read privilege, where “r” represents read permission. The middle character represents write privilege, where “w” represents write permission. The right character represents execute privilege, where “x” represents execute permission.

The extended attribute contains a client name of the file access device 300 which is permitted to access a file. For example, a client name, “melon”, is set in the extended attribute of the mode 141a. This means that only accesses from the file access device 300 with the client name of “melon” are granted.

The processing functions of the file management apparatus 1 illustrated in FIG. 1 are realized by operating the NFS server unit 130 and local file system unit 140 of FIG. 4 in cooperative manner. The processing functions of the file management apparatus 1 include a service ticket reception unit 1a, an identification information transmission unit 1c, a device access rights determination unit 1d, and a user access rights determination unit 1f. Further, the service ticket memory area 1bb of the device identification information memory unit 1b of FIG. 1 is realized by the service ticket memory unit 120 of FIG. 4. The authorized device name memory area 1ba of the device identification information memory unit 1b of FIG. 1 and the user access rights memory unit 1e are realized by the mode memory unit 141 of the local file system unit 140 of FIG. 4.

The following describes how a file is accessed in response to an access request from a user terminal.

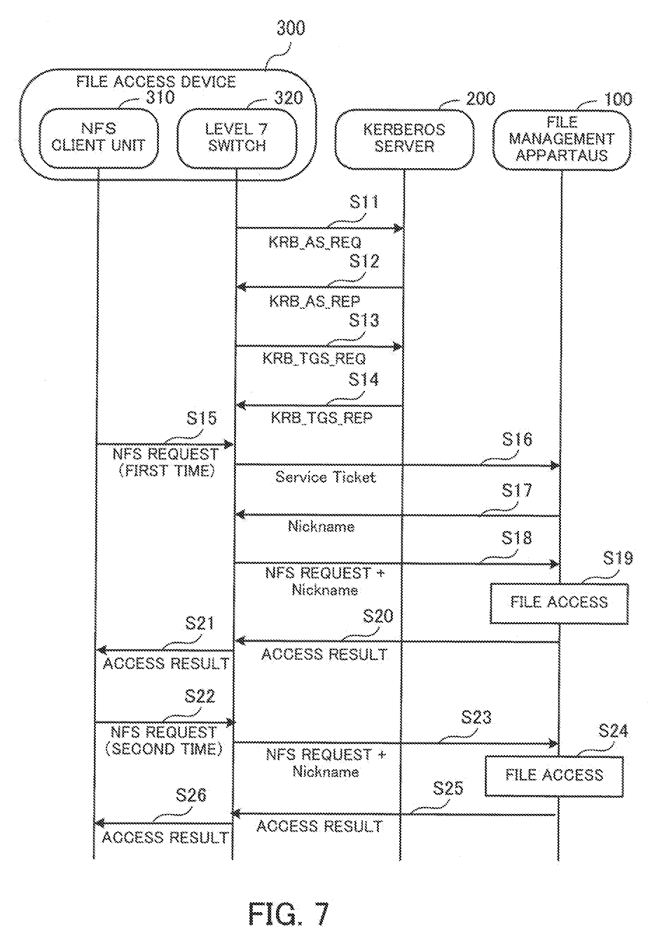

FIG. 7 is a sequence diagram of a file access process. This process will be described step by step.

[Step S11] When the file access device 300 is activated, the level 7 switch 320 issues a KRB_AS_REQ request to the Kerberos server 200 with a client name as an argument.

[Step S12] The Kerberos server 200 issues a KRB_AS_REP response to the level 7 switch 320. This KRB_AS_REP response includes a ticket granting ticket (TGT).

More specifically, the Kerberos server 200 has a key distribution center (KDC) database to previously store sets of the client name of a file access device 300, 400, . . . and a private key. Upon receipt of the KRB_AS_REQ request, the Kerberos server 200 checks whether the client name included in the KRB_AS_REQ request has been registered in the KDC database. If the client name has been registered, the Kerberos server 200 retrieves a private key corresponding to the client name from the KDC database. The Kerberos server then generates a first session key (K1) and a ticket granting ticket for realizing communication with the file access device 300. The Kerberos server 200 encrypts the first session key (K1) and the ticket granting ticket. For example, the Kerberos server 200 encrypts the session key by using the private key of the file access device 300 and encrypts the ticket granting ticket by using the private key of the Kerberos server 200. Then the Kerberos server 200 sends the file access device 300 the KRB_AS_REP response including the encrypted session key and the encrypted ticket granting ticket.

[Step S13] The level 7 switch 320 sends the Kerberos server 200 a KRB_TGS_REQ request with an identifier as an argument. More specifically, the level 7 switch 320 decrypts the received first session key (K1) with the own private key. Then the level 7 switch 320 generates an identifier as own identification information, and encrypts the identifier with the first session key (K1). Then the level 7 switch 320 sends the Kerberos server 200 the KRB_TGS_REQ request including the encrypted identifier, the ticket granting ticket received at step S12, and a service name. In this example, the service name is the name of a file management service provided by the file management apparatus 100.

[Step S14] The Kerberos server 200 sends the level 7 switch 320 a KRB_TGS_REP response including the service ticket. More specifically, the Kerberos server 200 decrypts the ticket granting ticket received from the file access device 300 to check whether its validity date has expired or not. The Kerberos server 200 decrypts the identifier with the session key (K1). If the identifier has been decrypted successfully, the Kerberos server 200 permits the file access device 300 to use the service. When permitting the use of the service, the Kerberos server 200 encrypts the service ticket for accessing the file management apparatus 100 by using the private key of the file management apparatus 100. Then the Kerberos server 200 sends the file access device 300 the KRB_TGS_REP response including the encrypted service ticket and the second session key (K2) encrypted by using the first session key (K1). The second session key (K2) is a session key for communication between the file access device 300 and the file management apparatus 100.

The level 7 switch 320 of the file access device 300 stores the service ticket and second session key (K2) included in the KRB_TGS_REP response in a memory device such as RAM. For example, the service ticket and second session key (K2) are stored in association with the service name of the service provided by the file management apparatus 100.

In this connection, the encrypted session key (K2) may be stored as it is, and then decrypted when used. Alternatively the second session key (K2) may be stored after decrypted. The second session key (K2) is decrypted with the first session key (K1) obtained at step S12.

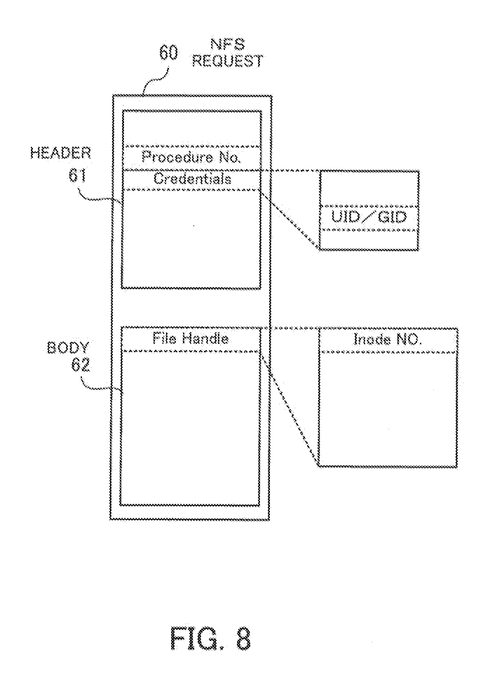

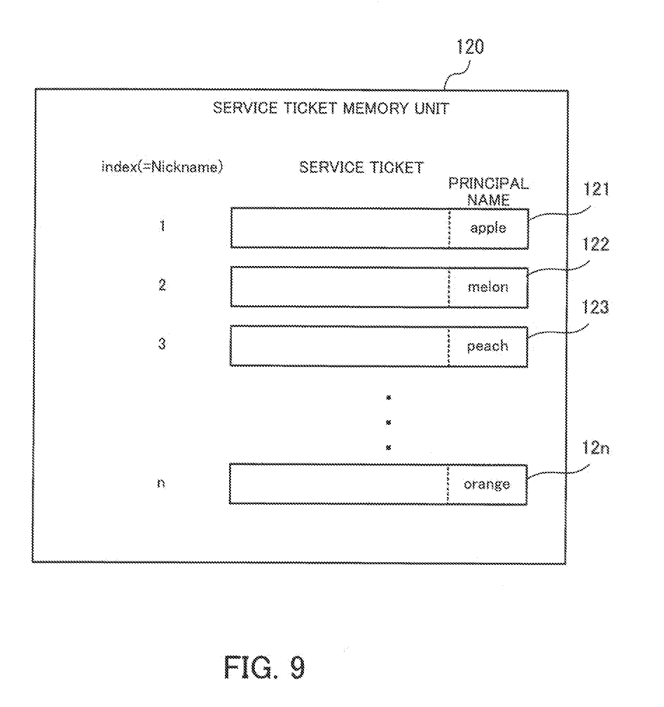

The above process is executed when the file access device 300 is activated. When an access request is sent from a user terminal 21, 22, 23, . . . to the file access device 300, the following process is executed.

[Step S15] The NFS client unit 310 of the file access device 300 outputs a first NFS request to the level 7 switch 320 in response to the access request from the user terminal 21, 22, 23, . . . . This NFS request specifies the file management apparatus 100 as an access destination. Each time an NFS request is issued, the NFS client unit 310 embeds the user's UID/GID information into the header part of an RPC (Remote Procedure Call). The NFS request will be described in detail later (refer to FIG. 8).

[Step S16] In response to the first NFS request, the level 7 switch 320 sends a service ticket to the file management apparatus 100. For example, the level 7 switch 320 sends the file management apparatus 100 the identifier identifying the file access device 300 and the service ticket which has been stored in association with the service name of the service provided by the file management apparatus 100. For example, the identifier sent to the Kerberos server 200 at step S13 is used as the identifier to be sent together with the service ticket. In addition, this identifier is encrypted with the second session key (K2) and then sent together with the service ticket.

[Step S17] Upon receipt of the service ticket, the NFS server unit 130 of the file management apparatus 100 sends a nickname to the file access device 300. More specifically, the NFS server unit 130 decrypts the identifier received from the file access device 300, by using the second session key (K2). If the identifier has been decrypted successfully, then the NFS server unit 130 decrypts the service ticket with the private key of the file management apparatus 100. The NFS server unit 130 stores the decrypted service ticket in association with the unique nickname in the service ticket memory unit 120. The nickname is data whose data size is smaller than that of the service ticket. Then the NFS server unit 130 sends the file access device 300 the nickname which has been stored in association with the service ticket. At this time, the NFS server unit 130 may encrypt the nickname with the second session key (K2). The data structure of the service ticket memory unit 120 will be described in detail later (refer to FIG. 9).

[Step S18] Upon receipt of the nickname, the level 7 switch 320 of the file access device 300 sends the file management apparatus 100 the NFS request having the nickname added thereto. More specifically, the level 7 switch 320 stores the nickname received as a response to the first NFS request, in a memory device such as RAM. For example, the level 7 switch 320 stores the nickname in association with the service name of the service provided by the file management apparatus 100. Then the level 7 switch 320 embeds the obtained nickname into the file handle of an NFS request, and sends the NFS request to the file management apparatus 100. If the nickname has been encrypted, the level 7 switch 320 decrypts the nickname with the second session key (K2).

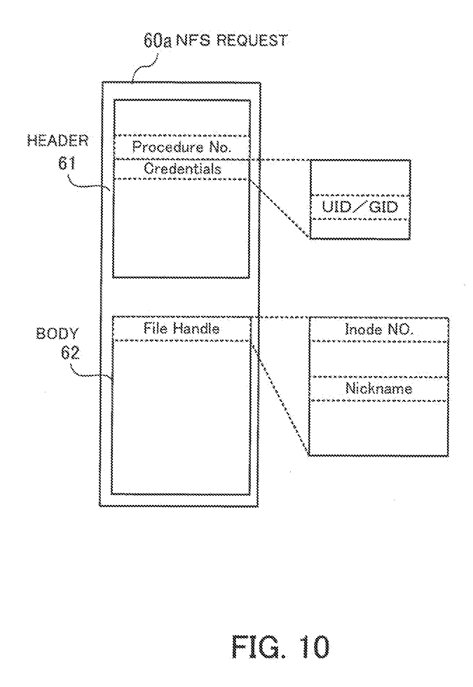

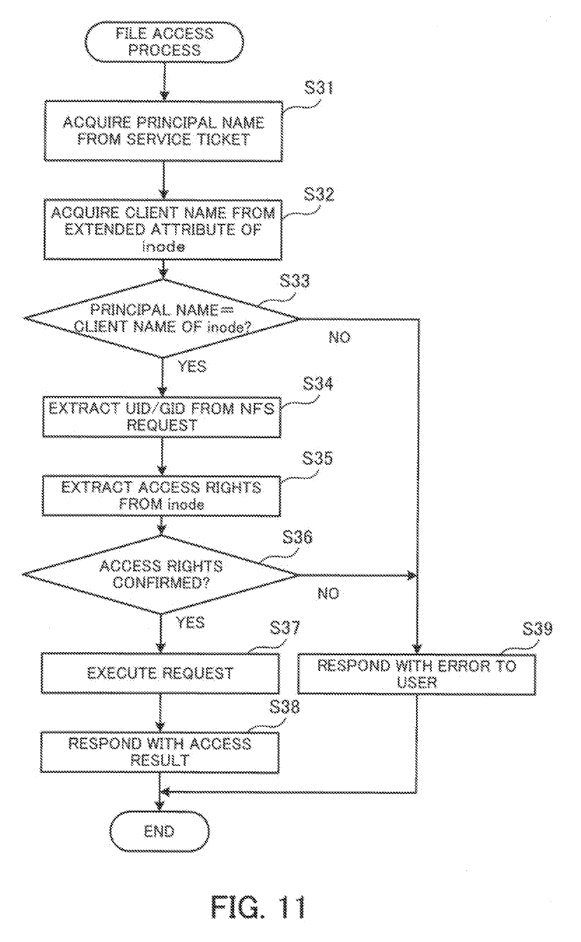

The reason that the nickname is sent instead of a service ticket is because the data size of the nickname is smaller than that of the service ticket and so may be included in the NFS file handle. That is, the nickname is generated so as to be included in the NFS file handle. An NFS request having a nickname added thereto will be described in detail later (refer to FIG. 10).

[Step S19] The NFS server unit 130 of the file management apparatus 100 determines whether to grant the access, based on the UID/GID and client name, and makes a file access according to the NFS request. This file access process will be described in detail later (refer to FIG. 11).

[Step S20] The NFS server unit 130 returns the result of the NFS request to the file access device 300.

[Step S21] The level 7 switch 320 of the file access device 300 gives the access result received from the file management apparatus 100 to the NFS client unit 310 which then forwards the access result to the user terminal which has sent the access request.

[Step S22] Then, when the file access device 300 receives a second access request from any of user terminals, the NFS client unit 310 gives the second NFS request to the level 7 switch 320. The second access request is an access request that the file access device 300 received second time. That is, even if the access request is output from a user terminal different from the user terminal which sent the first access request, the access request is treated as a second access request.

[Step S23] Upon receipt of a second or subsequent NFS request, the level 7 switch 320 attaches the nickname already acquired at step S17 to the NFS request, and sends the request to the file management apparatus 100. More specifically, the level 7 switch 320 recognizes that this request is a second or subsequent NFS request, from the fact that the nickname has been registered in the RAM in association with the service name of the service provided by the file management apparatus 100 that is a destination of the NFS request. Then, the level 7 switch 320 acquires the nickname associated with the service name of the service provided by the file management apparatus 100, and embeds it into the file handle of the NFS request. The level 7 switch 320 sends the file management apparatus 100 the NFS request having the nickname embedded therein.

[Step S24] The NFS server unit 130 of the file management apparatus 100 determines based on the UID/GID and client name whether to grant the access, and makes a file access according to the NFS request.

[Step S25] The NFS server unit 130 gives the result of the NFS request to the file access device 300.

[Step S26] The level 7 switch 320 of the file access device 300 gives the access result received from the file management apparatus 100 to the NFS client unit 310 which then forwards the access result to the user terminal which has sent the access request.

Upon a third or subsequent access request issued from a user terminal, the same process as steps S22 to S26 for handling the second access request is executed.

The following describes the data format of the NFS request which is sent from the file access device 300 to the file management apparatus 100.

FIG. 8 illustrates an example data structure of an NFS request to be output from an NFS client unit. The illustrated NFS request 60 is made up of a header 61 and body 62.

The header 61 includes a procedure number and credentials. The procedure number is an identification number identifying a request type. Request types include write request, read request, and execute request. The credentials are authentication information for access privileges and so on. The credentials include the UID and GID of a user using a user terminal which has issued the access request.

The body 62 includes a file handle which includes an mode number identifying a target file to be accessed.

The level 7 switch 320 which has received such an NFS request 60 sends a service ticket to the file management apparatus 100 which then issues a nickname. The file management apparatus 100 stores the service ticket in association with the nickname in the service ticket memory unit 120.

FIG. 9 illustrates an example data structure of a service ticket memory unit. The service ticket memory unit 120 stores a plurality of service tickets 121, 122, 123, . . . , 12n. Each service ticket 121, 122, 123, . . . , 12n has an index identifying a record in the service ticket memory unit 120. In this example, the index value is used as a nickname.

Each service ticket 121, 122, 123, . . . , 12n also has a principal name. The principal name is the name of a file access device which has been authenticated through the Kerberos authentication. The second embodiment uses the client name of each file access device as a principal name.

Upon receipt of the nickname from the file management apparatus 100, the level 7 switch 320 adds the nickname to the NFS request 60, and sends the request to the file management apparatus 100.

FIG. 10 illustrates an NFS request having a nickname added thereto. An NFS request 60a output from the level 7 switch 320 has a nickname in the file handle of the body 62. Having received such an NFS request 60a, the file management apparatus 100 identifies the service ticket based on the nickname included in the NFS request 60a. Identifying the service ticket corresponding to the NFS request 60a enables appropriate determination on access rights.

FIG. 11 is a flowchart of a file access process to be executed by an NFS server unit. This flowchart will be described step by step.

[Step S31] The NFS server unit 130 searches the service ticket memory unit 120 for a service ticket corresponding to the nickname included in the received NFS request. Then the NFS server unit 130 retrieves the principal name of the detected service ticket.

[Step S32] The NFS server unit 130 retrieves an mode corresponding to the mode number included in the received NFS request from the local file system unit 140, and then extracts the client name from the extended attribute of the obtained mode.

[Step S33] The NFS server unit 130 checks whether the principal name of the service ticket matches the client name of the mode. If there is a match, the process proceeds to step S34; otherwise, the process proceeds to step S39.

[Step S34] The NFS server unit 130 extracts the UID/GID from the header of the received NFS request.

[Step S35] The NFS server unit 130 extracts the UID/GID of the file owner and the access rights from the mode obtained at step S32.

[Step S36] The NFS server unit 130 compares the access rights included in the mode with the UID/GID extracted from the NFS request to determine whether the user identified by the UID/GID has access rights.

More specifically, the NFS server unit 130 compares the UID/GID extracted from the NFS request with the UID/GID extracted from the mode to search for the attribute of the user who has made the NFS request. The user attribute may be a file owner, a user of the file owner's group, or a user of another group. Matching UIDs means that the NFS request is from the file owner. Matching GIDs means that the NFS request is from a user of the file owner's group. No matching UIDs or GIDs means that the NFS request is from a user of another group. The NFS server unit 130 then obtains the access rights corresponding to the user attribute from access rights information. The access rights include write permission/prohibition, read permission/prohibition, and execute permission/prohibition. If the access type (write, read, or execute) included in the NFS request is allowed, the NFS server unit 130 determines that the access rights are confirmed.

If the access rights are confirmed, the process proceeds to step S37; otherwise, the process proceeds to step S39.

[Step S37] The NFS server unit 130 executes the request made to the file system. More specifically, the NFS server unit 130 requests the local file system unit 140 to make an access according to the NFS request. The local file system unit 140 accesses the target file of the storage device 110 according to the request, and returns the access result to the NFS server unit 130. If the access type is a write access, then a message of write completion is sent as the access result, for example. If the access type is a read access, then read data is sent as the access result, for example. If the access type is an access for executing a program in the file, then the program is sent as the access result, for example.

[Step S38] The NFS server unit 130 forwards the access result received from the local file system unit 140 to the file access device 300. Then, the file access process is completed.

[Step S39] As the principal name does not match the client name of the mode, that is, the user does not have access rights, the NFS server unit 130 sends an error message to the file access device 300 to inform the user.

As described above, only when a user having proper access rights makes an NFS request via a file access device having the same client name as is set in the mode of a target file, the target file is accessed according to the NFS requests. In other words, even if a file access device having a different client name from that set in an mode issues an NFS request, its access is denied irrespective of whether the access rights are confirmed or not through UID/GID authentication.

The following describes how to determine whether to grant or deny a file access, with reference to the mode memory unit 141 of FIG. 6 and the service ticket memory unit 120 of FIG. 9.

### First Example

Assume that an NFS request includes “mode number=3, Nickname=1, UID=5, GID=2, and procedure number=read”.

In this example, it is recognized based on the nickname of “1” included in the NFS request that the principal name corresponding to this nickname is “apple” (refer to FIG. 9). Then, the mode 141c with the mode number of “3” included in the NFS request in the mode memory unit 141 (refer to FIG. 6) is compared with the NFS request. The client name set in the extended attribute of the mode 141c is “orange”. The principal name and the client name of the mode do not match, and so this access is denied.

### Second Example

Assume that an NFS request includes “mode number=2, Nickname=3, UID=4, GID=2, and procedure number=write”.

In this example, it is recognized based on the nickname of “3” included in the NFS request that the principal name corresponding to this nickname is “peach” (refer to FIG. 9). Then, the mode 141b with the mode number of “2” included in the NFS request in the mode memory unit 141 (refer to FIG. 6) is compared with the NFS request. The client name set in the extended attribute of the mode 141b is “peach”. Therefore, the principal name and the client name of the mode match. On the other hand, the UID and GID included in the NFS request are “4” and “2”, respectively, whereas the UID and GID included in the mode 141b are “5” and “2”, respectively. Therefore, it is recognized that the NFS request is not from the owner of the target file but from a user of the owner's group. The access rights set in the mode 141b indicate that only read access permission is given to the users of the owner's group. However, the procedure number included in the NFS request indicates a write request. Therefore, the user who has made the NFS request has no access rights, and so this access is denied.

### Third Example

Assume that an NFS request includes “mode number=2, Nickname=3, UID=5, GID=2, and procedure number=write”.

In this example, it is recognized based on the nickname of “3” included in the NFS request that the principal name corresponding to this nickname is “peach” (refer to FIG. 9). Then, the mode 141b with the mode number of “2” included in the NFS request in the mode memory unit 141 (refer to FIG. 6) is compared with the NFS request. The client name set in the extended attribute of the mode 141b is “peach”. Therefore, the principal name and the client name of the mode match. On the other hand, the UID and GID included in the NFS request are “5” and “2”, respectively, whereas the UID and GID included in the mode 141b are “5” and “2”, respectively. Therefore, it is recognized that the NFS request is from the owner of the target file. The access rights set in the mode 141b indicate that write access and read access permissions are given to the owner. The procedure number included in the NFS request indicates a write request. Therefore, the user who has made the NFS request has access rights, and so this access is granted.

The above embodiments focus on determination on whether to grant or deny access regarding file operation. In addition, it may be determined whether to grant or deny access regarding directory operation in a similar way. More specifically, similarly to files, a directory is provided with an mode, and the client name of a file access device which uses files under the directory is set in the extended attribute of the mode. By doing so, a request for a list of files located under the directory or a request for creation or deletion of a file under the directory is granted only if the request is sent from the file access device having the same client name as is set in the mode of the directory.

When a file/directory is created under a directory in response to a creation request, the client name of the requesting file access device is stored in the extended attribute of the mode of the created file/directory. In this connection, the file/directory is created only after the client authentication for operating the parent directory is successful. Therefore, the client name of the requesting file access device which issued the creation request is set in the extended attribute of the mode of the created file/directory at the time of creating file/directory, which means that the same client name as the parent directory is stored. As a result, the client name of the parent directory is inherited by the new file/directory.

As described above, the second embodiment distributes Kerberos tickets to file access devices belonging to specified clients. Then, it is checked whether the client name of the extended attribute of a target file specified by a file system request matches the principal name of the ticket. Therefore, each client is able to protect own files from being accessed from the file access devices of the other clients. Even if a user of another client sends a file system request using the same UID/GID, mutual security is maintained. Therefore, UIDs/GIDs may be locally managed only on a client as in the case of the conventional technique, and a conflict of UIDs/GIDs between clients may not be considered.

In addition, the second embodiment makes it possible to keep on using the same UID/GID for setting user access rights. Therefore, even when user authentication in a file system is changed from the UID/GID authentication to the Kerberos one, individual users do not need to re-generate keys or reset access rights, which are supposed to be done. As a result, this change is immediately completed.

### [Other Applications]

The second embodiment performs Kerberos authentication on a file access device. However, another authentication method may be applied as long as it is possible to include a client name in a certificate of authentication.

The processing functions described above may be realized by a computer. In this case, a program is prepared, which describes processes for the functions to be performed by the file management apparatus 1, 100, the file access devices 2, 2a, . . . , 300, 400 . . . . The program is executed by a computer, whereupon the aforementioned processing functions are accomplished by the computer. The program describing the required processes may be recorded on a computer-readable non-transitory medium. Computer-readable non-transitory recording media include magnetic recording devices, optical discs, magneto-optical recording media, semiconductor memories, etc. The magnetic recording devices include Hard Disk Drives (HDD), Flexible Disks (FD), magnetic tapes, etc. The optical discs include DVDs, DVD-RAM, CD-ROM/RW, etc. The magneto-optical recording media include MO (Magneto-Optical disks etc.

To distribute the program, portable recording media, such as DVDs and CD-ROMs, on which the program is recorded may be put on sale. Alternatively, the program may be stored in the storage device of a server computer and may be transferred from the server computer to other computers through a network.

A computer which is to execute the program stores in its storage device the program recorded on a portable recording medium or transferred from the server computer, for example. Then, the computer runs the program.

The computer may run the program directly from the portable recording medium. Also, while receiving the program being transferred from the server computer, the computer may sequentially run this program.

In addition, at least a part of the above processing functions may be realized by electronic circuits such as DSP (Digital Signal Processor), ASIC (Application Specific Integrated Circuit), and PLD (Programmable Logic Device).

It is easy to integrate management of access rights to files for users using different file devices into one system.

The foregoing is considered as illustrative only of the principal of the present invention. Each component illustrated in the embodiments may be replaced with a component having the same functions. In addition, other configuration and steps may be desirably added to the invention. Further, two or more configurations (features) in the above embodiment may be combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A file management apparatus for managing files stored in a storage device, comprising:
a communication interface that receives from a file access device an access request for accessing a file, the access request including device identification information of the file access device and user identification information of a user; and
a control device that performs first determination on whether the file access device has access rights to the file, based on the received device identification information, performs second determination on whether the user has access rights to the file, based on the received user identification information, and when the first determination and second determination both determine that the access rights are confirmed, grants the access request for accessing the file.

2. A file management apparatus for managing files stored in a storage device, the file management apparatus comprising:
a processor configured to execute a procedure, the procedure comprising:
receiving from a file access device an access request for accessing a file, the access request including device identification information of the file access device and user identification information of a user; and
performing first determination on whether the file access device has access rights to the file, based on the received device identification information, performs second determination on whether the user has access rights to the file, based on the received user identification information, and when the first determination and second determination both determine that the access rights are confirmed, grants the access request for accessing the file.

3. A file management apparatus for managing files stored in a storage device, comprising:
a device access rights determination unit that, in response to an access request for accessing a target file, searches a device identification information memory unit to determine whether a file access device which has sent the access request has access rights to the target file, the access request including device identification information identifying the requesting file access device and a user identifier of a user who uses the target file, the device identification information memory unit storing device identification information of file access devices having access rights to the files;
a user access rights determination unit that, in response to the access request, searches a user access rights memory unit to determine whether the user identified by the user identifier included in the access request has access rights to the target file, the user access rights memory unit storing access rights to the respective files with respect to user identifiers; and
a file access unit that accesses the target file according to the access request when the file access device is confirmed to have the access rights and the user is confirmed to have the access rights.

4. A file management apparatus for managing files stored in a storage device, the file management apparatus comprising:
a memory configured to store device identification information of file access devices having access rights to the files and configured to store access rights to the respective files with respect to user identifiers; and
a processor configured to execute a procedure, the procedure comprising:
searching, in response to an access request for accessing a target file, the memory to determine whether a file access device which has sent the access request has access rights to the target file, the access request including device identification information identifying the requesting file access device and a user identifier of a user who uses the target file;
searching, in response to the access request, the memory to determine whether the user identified by the user identifier included in the access request has access rights to the target file; and
accessing the target file according to the access request when the file access device is confirmed to have the access rights and the user is confirmed to have the access rights.

5. A computer-readable, non-transitory medium recording thereon a file management program causing a computer to perform a procedure of managing files stored in a storage device, the procedure comprising:
in response to an access request for accessing a target file, searching a device identification information memory unit to determine whether a file access device which has sent the access request has access rights to the target file, the access request including device identification information identifying the requesting file access device and a user identifier of a user who uses the target file, the device identification information memory unit storing device identification information of file access devices having access rights to the files;
in response to the access request, searching a user access rights memory unit to determine whether the user identified by the user identifier included in the access request has access rights to the target file, the user access rights memory unit storing access rights to the respective files with respect to user identifiers; and
accessing the target file according to the access request when the file access device is confirmed to have the access rights and the user is confirmed to have the access rights.

6. The computer-readable, non-transitory medium according to claim 5, wherein the device identification information indicates that an authentication server has authenticated that the file access devices have proper access rights to the files.

7. The computer-readable, non-transitory medium according to claim 6, the procedure further comprising:
in response to a service ticket issued by the authentication server to the file access device having the proper access rights to the files, storing the service ticket in association with the device identification information of the file access device in the device identification information memory unit; and
sending the device identification information associated with the service ticket to the file access device which has sent the service ticket.

8. The computer-readable, non-transitory medium according to claim 7, wherein:
the service ticket includes a device name of the file access device having the proper access rights to the files;
the device identification information memory unit is divided into an authorized device name memory area and a service ticket memory area, the authorized device name memory area storing device names of the file access devices having the proper access rights to the respective files in association with the respective files, the service ticket memory area storing the device identification information and the service ticket in association with each other; and
in order to determine whether the file access device has the access rights, the service ticket memory area is searched to retrieve the device name corresponding to the device identification information included in the access request, and when the retrieved device name is found in the authorized device name memory area in association with the target file, the file access device which has sent the access request is confirmed to have the access rights.

9. The computer-readable, non-transitory medium according to claim 8, wherein the authorized device name memory area is part of file management information which is used for managing the files by a local system managing the storage device.

10. The computer-readable, non-transitory medium according to claim 8, wherein the service ticket is issued by a Kerberos server that performs Kerberos authentication, and the device name is stored in a field for setting a principal name in the service ticket.

11. The computer-readable, non-transitory medium according to claim 7, wherein the device identification information has a data size smaller than the service ticket.

12. A file management method to be executed by a computer to perform a procedure of managing files stored in a storage device, the procedure comprising:
in response to an access request for accessing a target file, searching a device identification information memory unit to determine whether a file access device which has sent the access request has access rights to the target file, the access request including device identification information identifying the requesting file access device and a user identifier of a user who uses the target file, the device identification information memory unit storing the device identification information of file access devices having access rights to the files;
in response to the access request, searching a user access rights memory unit to determine whether the user identified by the user identifier included in the access request has access rights to the target file, the user access rights memory unit storing access rights to the respective files with respect to user identifiers; and
accessing the target file according to the access request when the file access device is confirmed to have the access rights and the user is confirmed to have the access rights.
